(19) United States
(12) Patent Application Publication
(10) Pub. No.: US 2021/0387918 A1
(43) Pub. Date: Dec. 16, 2021

(54) IMPROVED, FUNCTIONAL, PHOTOCATALYTIC BUILDING MATERIALS AND PROCESSES FOR PREPARING THEM

(71) Applicant: LDV GREEN TECH S.R.L., L'aquila (IT)

(72) Inventors: Antonello LUDOVICI, L'aquila (IT); Luigino GRAVELLI, L'aquila (IT)

(73) Assignee: LDV GREEN TECH S.R.L., L'aquila (IT)

(21) Appl. No.: 17/287,840

(22) PCT Filed: Oct. 22, 2019
(86) PCT No.: PCT/IB2019/059005

§ 371 Date: Apr. 22, 2021

(30) Foreign Application Priority Data
Oct. 22, 2018 (IT) 102018000009655

(51) Int. Cl. C04B 28/26; B01J 21/06; B01J 35/00; C04B 14/06; C04B 14/10; C04B 22/06; C04B 40/00; B28B 3/02; B28B 11/08

(52) U.S. Cl. CPC C04B 28/26; B01J 21/063; B01J 35/004; C04B 14/06; C04B 14/10; C04B 2111/00827; C04B 40/0046; C04B 40/0067; B28B 3/022; B28B 11/0845; B28B 11/0818; C04B 22/06

(57) ABSTRACT

A process produces building materials with inert materials capable of remaining durably solid and with a low environmental impact. The process includes mixing sand, sodium hydroxide and possibly additives, adding calcined kaolin, adding sodium silicate and/or a mixture of sodium silicate and potassium hydroxide, and adding photocatalytic titanium dioxide.

### TECHNICAL FIELD OF THE INVENTION

The present invention finds application in the building field.

### BACKGROUND ART

In construction, the term cement, or more specifically hydraulic cement, means a variety of construction materials, known as hydraulic binders, which when mixed with water develop adhesive properties or hydraulic properties. Cement plus water is used as a binder mixed with inert materials such as sand, gravel or crushed stone to create building materials. Portland cement, which is the most widely used binder in construction and cementitious products, is produced by clinker pulverization, obtained by baking a mixture of calcium oxide (CaO) minerals at very high temperatures, generally obtained from limestone, silicon oxide (SiO₂), aluminum oxide (Al₂O₃), iron oxide (Fe₂O₃) and magnesium oxide (MgO). The theoretical energy required to produce the clinker is about 1,700 Joules per gram, but due to the dispersions the value is much higher and can reach up to 3,000 Joules per gram. This involves a considerable energy demand for the production of cement, and, therefore, the release into the atmosphere of important quantities of carbon dioxide (CO₂), a greenhouse gas. The problems related to the use of this material are:
as mentioned above, the amount of carbon dioxide released into the atmosphere, which is on average equal to 1.05 kg of CO₂ per 1 kg of Portland cement clinker produced, plus other toxic gases such as nitrogen oxides (NOₓ) and sulfur oxides (SOₓ).
for each ton of cement, around 150 kg of powders are generated, which cause respiratory problems in the population living in the vicinity of the production plants.
the transport of Portland cement from the factory to the construction site, which produces noise, dust, traffic and pollution.

The prior art document DATABASE WPI Week 200836 Thomson Scientific, London, GB; AN 2008-F40603 & CN 101138859 A (HUO L) 12 Mar. 2008 describes the use of titanium dioxide as a pigment, in particular, in the powder form; the specific product used (Guangzhou City as Paint Oil Pigment Co., Ltd.) is insoluble in the solvent and in the carrier in which it is dispersed.

The same document mentions a process of preparing an artificial stone material using the vacuum pressing method, which requires longer drying times, thus limiting the applications of the process or excluding some.

The prior art document US 2013/0133555 describes the use of photocatalysts such as anatase (titanium dioxide) which produce superoxides which can oxidize NOx and VOC to reduce pollution. Such photocatalysts can make the system super-hydrophobic. The document also describes the use of fly ash (whose production guarantees a low reproducibility of performance) and of highly polluting aluminum tricalcium. Using calcium aluminate, which includes about 10% iron oxide III, Portland cement is obtained.

The aforementioned problems are solved by the present invention, which provides functional and aesthetically valuable substitute products for cement, capable of being activated with a photochemical action, as well as the methods to obtain them.

### OBJECT OF THE INVENTION

An object of the invention is to provide building materials that replace cement.

An object of the invention is to produce building materials only with inert materials and chemical products which, through an exothermic reaction, are capable of developing adhesive properties.

An object of the invention is to produce building materials which are improved in appearance or coated with more valuable materials than those already used.

An object of the invention is to produce building materials also using recycled materials or waste materials from other industrial processes.

An object of the invention is to provide building materials adapted to withstand superficial mechanical embellishment processes.

An object of the invention is to provide building materials with hydrophobic properties, or water repellent and/or with antifreeze products.

Another object is to produce photocatalytic building materials.

Another object is to produce photocatalytic building materials which have anti-pollution properties.

Another object is to produce photocatalytic building materials which maintain their features unchanged over time.

Still another object is to provide apparatuses and methods for producing semi-finished products to make improved photocatalytic building materials.

Another object is to produce photocatalytic building materials by means of easily industrializable processes.

Another object is to produce photocatalytic building materials for the production of self-locking blocks, tiles, roofing products, cement replacement blocks, gutters and channels for collecting water and for roads, guardrails, T or L panels for constructing fencing walls, sound-absorbing panels, cladding panels for covering piling and/or soldier pile walls for the construction of road underpasses, wing walls, artificial tunnels, bulkheads, crowning cornices for bridge decks, all photocatalytic.

Another object is to provide compositions of colloidal solutions and suspensions based on photocatalytic titanium dioxide which can be distributed at room temperature from 2° C. to 80° C. for the preparation of photocatalytic building materials active in the UV spectrum capable of purifying the surrounding environment and to decompose the organic carbon-based compounds that are deposited on the surface.

### BRIEF DESCRIPTION OF THE FIGURES

FIGS. 1 to 4 show four embodiments within the scope of the present invention;

FIG. 5 shows a graph with the results of the tests on the photocatalytic activity;

FIG. 6 is a representation of the instrumental apparatus;

FIG. 7 shows the graph of the results of the nitrogen oxides abatement test, whose data are reported in the table of FIG. 8.

### DETAILED DESCRIPTION OF THE INVENTION

### Titanium Dioxide

Titanium dioxide is a semiconductor material with a crystalline structure, having a valence band separated from a conduction band by a given energy difference.

Like most materials, titanium dioxide absorbs energy from radiation when struck by electromagnetic radiation. When the absorbed energy is greater than the energetic difference between the valence band and the conduction band, an electron is promoted from the valence band to the conduction band, generating an excess of electronic charge (e⁻) in the conduction band and a gap of electrons (h⁺) in the valence band. Titanium dioxide is in the solid state at room temperature in a crystalline form such as anatase, rutile or brookite. Anatase is the most active crystalline form from the photocatalytic point of view and has an energy difference between the valence band and the conduction band of 3.2 eV. It follows that, if this material is irradiated with photons having energy greater than 3.2 eV, i.e. with an electromagnetic radiation of wavelength from 380 nm to 420 nm, an electron is promoted from the valence band to the conduction band. This happens in particular when titanium dioxide is hit by ultraviolet (UV) radiation, for example emitted by an ultraviolet lamp, or by solar radiation. Electronic gaps can oxidize most organic compounds. Such electronic gaps can, for example, react with a water molecule (H₂O) generating a hydroxyl radical (.OH) which is highly reactive. The excess electrons have a very high reducing power and can react with the oxygen molecule to form the superoxide anion (O₂^{⋅-}). The oxidation reaction of the water molecule is shown in the diagram (I) and the oxygen reduction reaction is shown in the diagram (II):

TiO₂(h⁺)+H₂O→TiO₂+.OH+H⁺; (Ī)

TiO₂(e⁻)+O₂→TiO₂+O₂⋅− (ĪĪ)

The hydroxyl radical (.OH) is particularly active both for the oxidation of organic substances, for example present in the air, and for the inactivation of microorganisms, which for example can be harmful to humans.

In particular, the organic compounds are oxidized to carbon dioxide (CO₂) and water (H₂O), the nitrogen compounds are oxidized to nitrate ions (NO₃⁻), the sulfur compounds to sulfate ions (SO₄²⁻). Titanium dioxide is also capable of decomposing many gases or harmful substances, such as thiols or mercaptans, formaldehyde, ammonia, having an unpleasant smell. The decomposition of these gases or substances eliminates the bad smells associated with them.

The different behavior of rutile titanium dioxide compared to anatase titanium dioxide is due to:
the different amount of energy necessary for the excitation of an electron from the valence band to the conduction band of these two forms: 388 nm for anatase and 413 nm for rutile, and
the different reducing/oxidizing power, respectively of the excited electron and the generated electronic gap, which is high for anatase and low for rutile.

### Zeolites

Zeolites are crystalline aluminosilicates with three-dimensional structure that form uniform pores of molecular size. Zeolites absorb molecules that are inserted inside the microholes and exclude molecules that are too large, that is, they act as sieves on a molecular scale. Due to their unique features, they include ion exchange and adsorption properties. Ion exchange is a chemical-physical process consisting in the exchange of the cation contained within the crystalline structure with ions present in solution that have dimensions and electrostatic properties compatible with the structure within which they are inserted. Natural zeolites containing Na+ or K+ cations are able to exchange ionic species such as Ca²⁺ and Mg²⁺, respectively. They have an alveolar structure, therefore by adsorption they can trap water, carbon dioxide, gas, heavy metals, radioactive substances, toxins and more. Zeolites are also able to balance the pH of a solution.

### Geopolymers

In order to better understand and implement the first aspect of the invention, geopolymers must be introduced. Geopolymers have been extensively studied in relation to their considerable versatility in different fields of application, linked to the non-flammability of the aggregates present and to the remarkable mechanical properties sometimes higher than those of traditional cements. In 1973 J. Davidovits gave the first definition of geopolymers defining them as “Inorganic polymers formed by natural aluminosilicates”, and saw their first application as fire-resistant building products. Davidovits used various sources of siliceous materials containing aluminosilicates which were added to concentrated alkaline solutions for dissolution and subsequent polymerization. Many processes for making a geopolymer are therefore based on the union of aluminosilicates and alkaline solutions, namely mixtures of sodium hydroxide (NaOH) and/or potassium hydroxide (KOH) and sodium silicate (Na₂SiO₃) and/or potassium silicate (K₂SiO₃). Geopolymers have a great resistance to compression and abrasion, it is possible to program hardening for adaptation to industrial production, they have a flame resistance of over 900° C., and do not produce toxic gases. They are also resistant to acids and bases, have a minimum dimensional shrinkage compared to cement and a low thermal conductivity. Additional advantages are: adhesion to various types of cement, including glass, recycled materials, ceramics, as well as the possibility of containing steel, metals, stones, waste or valuable powders or other building materials. Last but not least, geopolymers have proved to be easy to mold in the industrial process. All these features can be concentrated in a single product, but each semi-finished product described in the present invention has different features.

According to the present invention, a process for the preparation of a composite building article is described, which comprises the steps of:

I) mixing sand, sodium hydroxide and possibly additives,
II) adding calcined kaolin (or metakaolin) to the mixture obtained from step I),
III) adding sodium silicate and/or a mixture of sodium silicate and potassium hydroxide to the mixture obtained from step II) obtaining said article or a semi-finished product of said article,
wherein titanium dioxide is added, and possibly additives. In an aspect of the present invention, in step I) gravel may be added.

Preferably, the gravel has a caliber of about 0.1-12 mm and more preferably of 6-8 mm.

For the purposes of the present invention, titanium dioxide is photocatalytic titanium dioxide.

In a particular aspect of the process, in step I) zeolite is added as an additive.

According to an embodiment, in step I) the sand is replaced with a powdered material selected from the group comprising: powders of marble, quartz, granite, porphyry, travertine, basalt, mixed stone, grits, glass, ceramic, earthenware, terracotta, metal powders.

In a preferred aspect, said powdered material has a granulometry comprised between about 0.01 and 6 mm, and preferably between about 0.1 and 3 mm.

According to an aspect of the invention, the photocatalytic titanium dioxide is added in step I).

In particular, the photocatalytic titanium dioxide is added by application to the manufactured article or to the semi-finished manufactured article obtained.

Preferably, the application to the article is carried out by spray coating.

For the purposes of the present invention, photocatalytic titanium dioxide is added in the form of amorphous colloidal solution.

According to an aspect of the present invention, the solution, the amorphous colloidal solution may comprise one or more of the compounds selected from: hydroxyapatite, amorphous colloidal silica, modified polyether, surfactants.

In any case, for the purposes of the present invention, the solution comprising amorphous colloidal titanium dioxide is a hydrophilic preparation, i.e. in contact with the surface it has a contact angle close to zero; in fact, analyses carried out show a contact angle from 0.7° to 5.0°.

According to a preferred aspect of the present invention, the process for the preparation of the article described does not include the use of fly ash, which is harmful to the environment.

According to another preferred aspect, the process of the present invention does not involve the preparation or use of Portland cement (not comprising the use of iron oxide III).

The manufactured building article according to the process described in the present patent application represents a further object of the invention.

According to an embodiment, the process for preparing a composite building article, which includes the steps of:
preparing a first semi-finished article according to the present invention,
preparing such semi-finished article in a suitable mold before it dries,
vibro-compressing such first semi-finished article for a sufficient time,
preparing a second semi-finished product according to the present invention,
superposing such second semi-finished article to the first one before it dries, and
vibro-compressing the first and the second semi-finished products, thus obtaining a composite building article.

For the purposes of the present invention, in a preferred aspect the vibro-compression is not carried out under vacuum. Advantageously, the process of the present invention allows obtaining products in a very short time (even only 20 seconds) and requires drying times of 96 hours; these times are not possible with different procedures, such as, for example, the application of vacuum.

According to a preferred aspect, such process may comprise the further step of:

IV) applying a first layer means over the composite building article.

In an embodiment of the invention, this first layer means is represented by a preparation having a hydrophobic or antifreeze or reflecting/luminescent property.

In an alternative embodiment, this first layer means is instead represented by a preparation comprising titanium dioxide, on which a second layer means is subsequently applied, represented by a preparation having a hydrophobic or antifreeze or reflecting/luminescent property.

According to a preferred aspect of the invention, when titanium dioxide is included in the mixture which forms one of the semi-finished articles, it is not also included in a layer means.

In a further aspect of the invention, said first and/or second layer means may further comprise other powdered, liquid, microsphere, glass grit, laminar material or any other form suitable for mixing.

Preferably, the first and/or second layer means are applied by spray coating or by mixing.

Also the composite article thus obtained is an object of the present invention.

According to a preferred aspect of the invention, the article obtained according to the processes described above can be subjected to further treatments.

In particular, these treatments can be selected from the group comprising: smoothing, bush-hammering, brushing, sandblasting, tumbling or other treatments capable of imparting a greater added value to the finished article.

For the purposes of the present invention, the building article or the composite building article described above are represented by a tile, a self-locking tile.

From the qualitative point of view, materials with a fine aesthetic appearance are obtained which can be processed according to well-established techniques applied in the field: milling, bush-hammering; in fact, the mechanical features of concrete can be advantageously achieved.

To make our first semi-finished product, the first ingredient used in the production of self-locking blocks is sand. Selected silica-free sands of clay are used in this first step. This inert material in different periods of the year has a variable, non-constant humidity content, depending on the various granulometries of the inert material and the state of preservation. Using a thermobalance, the percentage of humidity contained in it was analyzed. It is important to focus attention on humidity in consideration of the fact that in order to eliminate the same energy must be developed, through an exothermic reaction using for the purpose sodium hydroxide (NaOH) and/or activated zeolite (Na₂Al₂Si₃O₁₀.2H₂O). The gravel having a caliber from 0.1 to 12 mm, preferably from 6 to 8 mm, was then added to the freshly prepared mixture composed of silica sand, zeolite and/or sodium hydroxide. Said gravels preferably represent 30% of the weight of the mixture with a tolerance of ±10%.

In a first comparative experiment, 5.0 g of NaOH were added to 30.0 g of demineralized H₂O. The initial water temperature, measured with a digital thermometer with a titanium probe, is 25.1° C.

In the first experiment there is an exothermic reaction which raises the temperature of the H₂O from 25.1° C. to 57.6° C. with an energy production of +32.5 cal which correspond to 135.98 J.

Our first exothermic pre-reaction to obtain the geopolymer of the invention comprises raising the temperature of the silicate sand by providing from a minimum of 4 J to a maximum of 12 J of energy for each gram of H₂O present in the silicate sands themselves. The energy required varies according to the granulometry and the degree of humidity. Therefore, to achieve this first result, a minimum quantity ranging from 1.0% to a maximum amount of 8.0% by weight of sodium hydroxide (NaOH), preferably 2-3% will be added to the silicate sand which represents 56.45% in this formula with a tolerance of ±10%. In a second experiment conducted, 5.0 g of activated zeolite (Na₂Al₂Si₃O₁₀.2H₂O) were added to 30.0 g of demineralized H₂O. The initial temperature of the water, measured with a digital thermometer with a titanium probe, is 25.2° C. In the second experiment, there is an exothermic reaction which raises the temperature of the H₂O from 25.2° C. to 35.9° C. with an energy production of +10.7 cal corresponding to 44.80 J. The difference A % of the two exothermic reactions measured in the first and second experiments is equal to 67.05%. The amount of zeolite to be added to step I) ranges from a minimum of 1.0% to a maximum of 8.0%, preferably 2.92%.

At this point the three elements silicate sand, zeolite and/or sodium hydroxide begin a first geopolymerization reaction. A semi-crystalline polymineral resin is formed, which acts as a glue for the raw materials based on aluminosilicates which have not reacted or for any charges that make the material functional, or for the additional raw materials that will be added later, bind to the gravel, optimizing specific physical or mechanical properties depending on the applications for which this first semi-finished product is intended.

In a second step for making the first semi-finished product, calcined kaolin is added.

This preferably has the following composition: 42.60% Silica (SiO₂); 28.20% Aluminum oxide (AL₂O₃); 21.20% Calcium oxide (CaO); 1.94% Magnesium oxide (MgO); 1.48% Titanium dioxide (TiO₂); 1.42% Ferric oxide (Fe₂O₃); 1.01% Sulfur trioxide (SO₃); 0.52% Potassium oxide (K₂O); 0.42% Hypomanganose oxide (MnO); 0.21% Chlorine (Cl); other unidentified 1%. The amount of calcined kaolin to be added to step I ranges from a minimum of 2.0% to a maximum of 16.0%, preferably 7.31%.

In the third step for making the first semi-finished product and in order to activate the second geopolymer reaction, sodium silicate (Na₂SiO₃) and/or a formula composed of sodium silicate (Na₂SiO₃) plus potassium hydroxide (KOH) is added. The chemical composition of sodium silicate (Na₂SiO₃) where sodium represents from a minimum of 25% to a maximum of 45%, preferably 36% and where the silicate represents from a minimum of 15% to a maximum of 35% preferably the 24%. The chemical composition of sodium silicate plus potassium (KNa₂SiO₄) in addition to what has been said for sodium silicate (Na₂SiO₃), potassium hydroxide represents from a minimum of 1% to a maximum of 10%, preferably 5%. Providing extra soluble silicates which act as a binder or plasticizer, thus determines denser structures, improves the development of Si—O—Al bonds in addition to the workability of the mixture. The chemical-polymineral mixture formed by the geopolymerization described above creates the first semi-finished product.

In order to make the second semi-finished product, inert materials of different granulometries are used. It is known that the self-locking blocks manufactured today have the surface part constructed differently than the underlying part that will be consolidated to the ground. To obtain this second semi-finished product, silicate sand up to about 87% is added to all the ingredients listed and according to the scheme shown above in relation to the preparation of the “First semi-finished product”, with a tolerance of ±10%.

According to an aspect of the present invention which contributes to the manufacture of the second semi-finished product, the silicate sand can be replaced, without prejudice to the quantities used, with more valuable materials, which confer different aspects and to obtain more valuable building materials or in this case a self-locking solid block. Silicate sand can therefore be replaced by powders of marble, quartz, granite, porphyry, travertine, basalt, stone, grit, glass, ceramic, earthenware, terracotta or metal powders, having a gauge from 0.01 to 6.0 mm, preferably from 0.1 to 3 mm. Then, using said chemical-polymeric mixtures our second semi-finished product is obtained.

“Layer means” and “Additional layer means”

According to a further aspect of the present invention, it is possible to add “layer means”.

According to an embodiment of the invention, said layer means and/or said further layer means are photocatalytic layer means.

More particularly, said photocatalytic layer means comprise powdered titanium dioxide, preferably in the form of anatase and/or in the form of rutile, amorphous colloidal titanium dioxide in aqueous solution, amorphous colloidal titanium dioxide in alcohol solution.

In an embodiment, said layer means, and/or said further layer means, may comprise other powdered, liquid, microsphere, glass grit, laminar material or any other form suitable for mixing with titanium dioxide-based compounds.

According to an aspect of the present invention, additives may be added to the titanium dioxide solutions and/or may comprise hydroxyapatite [Ca₅(PO₄)₃(OH)].

If present they will have a concentration ranging from about 0.1% to about 5.0% by total weight of the prepared mixture, preferably 1.0% by weight of the prepared mixture.

In another embodiment, the additives may further comprise Smectite and/or a derivative thereof and/or compounds based on Smectite; if present, they have a concentration ranging from about 0.1% to about 5.0% by total weight of the prepared mixture, preferably 1.0% by weight of the prepared mixture.

In a further embodiment, the mixtures may further comprise silica (SiO₂), preferably in colloidal form; if present, this is in a concentration ranging from about 0.5% to about 5.0% by total weight of the prepared mixture, preferably 1.0% by weight of the prepared mixture.

According to a still further embodiment, the mixtures of additive may further comprise one or more substances with a surfactant action, preferably in a weight concentration ranging from about 0.001% to about 1.0% by total weight of the prepared mixture, preferably 0.01% by weight of the prepared mixture.

In another embodiment, the titanium dioxide for making the layer means, and/or the further layer means, is usually in the form of an aqueous colloidal solution, possibly in the amorphous state, containing titanium in the form of anatase, and/or titanium in the form of rutile and/or brookite.

For the preparation of the layer means and of the further layer means, mixtures having a titanium titer in the various forms ranging from about 0.5% to about 20% by weight may be used. The titanium present in the mixtures used to obtain the layer means, and/or the further layer means, may all be in the form of 100% Anatase, or titanium-containing mixtures in the form of anatase in a percentage ranging from about 70% to about 90% and titanium in the form of rutile and/or brookite in a percentage ranging from about 10% to about 30% may be prepared. Titanium dioxide may be used in powder and/or colloidal solution, even amorphous and may contain additives.

According to an aspect of the invention, the photocatalytic titanium dioxide is included in the second semi-finished product, preferably in a concentration ranging from about 1.0% to about 15.0% by total weight of the prepared mixture, preferably 7.0%.

To make a second amorphous colloidal suspension of photocatalytic titanium dioxide as an ingredient of a semi-finished article and/or as a layer means, 30 ml of glacial acetic acid=>99%.9 (CH₃CO₂H) from Merck were put in a beaker, and distilled and demineralized water was added to bring the solution to 500 ml. At a speed of 2,000 RPM, 200 g of Aeroxide® P25 were slowly added. To mix the solution a dynamic mixer from Brabender® was used until a pasty solution without lumps was obtained. With the addition of further additives the mixture was further mixed. In order to make the substrate on which the formula will be applied hydrophilic, 50 g of Evonik pyrogenic colloidal silica, Aerosil® series (hydrophilic fumed silica), having a BET (specific surface area measured in m²/g) of from 90 to 300 were further added to the mixture. 50 g of hydroxyapatite from Taihei Chemical Industrial Co., Ltd. (JP) were further added to the mixture which will ensure a particular function to the substrate, that of absorbing a certain quantity of pollutants, gases and odors overnight, which the titanium dioxide in the case of the absence of light radiation cannot do. The combination of the two products creates a ‘Night and Day’ function. When titanium dioxide is irradiated by a light source it decomposes the organic compounds that are deposited on the surface, even those captured by hydroxyapatite. During the night phase, hydroxyapatite absorbs and traps them, then the cycle is repeated. It is also possible to replace the Aeroxide® P25 with the Aeroxide® P90 again from the company Evonik and/or with the KronoClean 7000 and the KronoClean 7050 from the company Kronos. Said formula containing titanium dioxide can be present in a concentration of between about 5% by weight and about 20% by weight, preferably 10% by weight and constitutes an ingredient of the semi-finished product. It may be present in a concentration ranging from about 10 g/m² to about 100 g/m², preferably 50 g/m² and constitutes a layer means. The also amorphous colloidal suspensions of photocatalytic titanium dioxide listed thus far also containing additives, or the additional layer means, may be used in combination or separately.

In an alternative embodiment of the present invention, the photocatalytic titanium dioxide is in liquid form and can be applied by spray coating only on the second semi-finished product as a layer means; for this purpose, it may be present in a concentration of between about 10 g/m² and about 120 g/m², preferably 60 g/m².

To make an amorphous colloidal suspension of photocatalytic titanium dioxide to be applied by spray coating to our invention as a layer means, 500.0 g of demineralized water were placed in a borosilicate beaker. Using a magnetic stirrer with a hot plate, the temperature was set to 100° C. A magnetic stir bar was inserted into the beaker to shake the solution. When H₂O reaches 45° C., 10 g of smectite are added and stirred for 5 minutes. 10 g of photocatalytic titanium Kronos, called KronoClean 7000, are added and stirred for a further 5 minutes. Of a solution 1/10 in H₂O previously prepared, 0.5 g of modified KF polyether from the company Shin-Etsu Chemical CO., Ltd. (JP) are added and stirred for a further 5 minutes. It is possible to add, if required, in order to make the substrate on which the formula will be applied hydrophilic, Evonik pyrogenic colloidal silica, Aerosil® series (hydrophilic fumed silica), in the quantities already listed, having a BET (specific surface area measured in m²/g) of from 90 to 300. At this point the solution is passed, with the aid of a peristaltic pump, from the beaker to the sonicator. The Misonix 3000 sonicator used is able to deliver 600W to the probe and able to make the particles homogeneous through ultrasound. The sonicator is equipped with Flocellsm, able to process continuously up to 20 l/min of solution to be sonicated. The sonication causes the smectite to explode, creating a semi-liquid gelatinous solution, ideal for spray applications. The solution is further homogenized/emulsified using a T 65 digital ULTRA-TURRAX® to give the product a longer duration over time. KronoClean 7000 titanium dioxide may be replaced with KronoClean 7050 if the photochemical reaction spectrum is to be increased from 380 to 480 nm. It is known that titanium dioxide is active in a light spectrum ranging from 380 to 420 nm, nitrogenous substances and/or nitrogen (N) can raise the spectrum from 380 to 480 nm or to the limit of the visible spectrum. It is also possible to replace the KronoClean 7000 and the KronoClean 7050 with the Aeroxide® P25 and/or the Aeroxide® P90 from the company Evonik.

According to a further embodiment of the present invention, the addition of materials and/or chemical products to be used as further layer means and/or as ingredients of semi-finished products is provided.

In a preferred embodiment of the invention, when titanium dioxide is present as a component of the semi-finished product, i.e. a first or second semi-finished product, there are no layer means comprising titanium dioxide.

For this purpose, further layer means may comprise primers with a high compaction level or in liquid form which increase the hydrophobic action and the resistance and/or the complete water-repellence, which therefore allow greater adhesion between the semi-finished product and the photocatalytic layer means. The hydrophobizing primer applied to the surface of the self-locking block may be present in a concentration ranging from about 5 g/m² to about 100 g/m², preferably 50 g/m² and constitutes a layer means.

According to a further embodiment, further layer means may be provided applied to the semi-finished products to be obtained, for example, an antifreeze and/or de-icing effect. The antifreeze applied to the surface of the self-locking block may be present in a concentration ranging from about 20 g/m² to about 200 g/m², preferably 120 g/m² and constitutes a layer means.

Further layer means or ingredients of semi-finished products may be applied to the semi-finished articles to be obtained, for example, a reflecting and/or luminescent effect, useful in road paving during the night. Said layer means applied on the surface of the self-locking block, in the form of paints for example, may be present in a concentration of between about 10 g/m² and about 100 g/m² each, preferably 50 g/m² and constitute layer means. Said photoluminescent materials may be powdered in the form of pigments, glass grit, in the form of pebbles and may be applied to the semi-finished products as ingredients. For this purpose, photoluminescent glass grit was used, present in a concentration ranging from about 80% to 100% by weight of the semi-finished product, preferably 100.0%.

In a further aspect of the invention said semi-finished products and/or manufactured articles and/or layer means may undergo, after the manufacture and at the end of drying, mechanical modifications such as: sanding, bush-hammering, brushing, sandblasting, tumbling and others capable of giving greater value to the finished product.

The present invention is further described in the following examples.

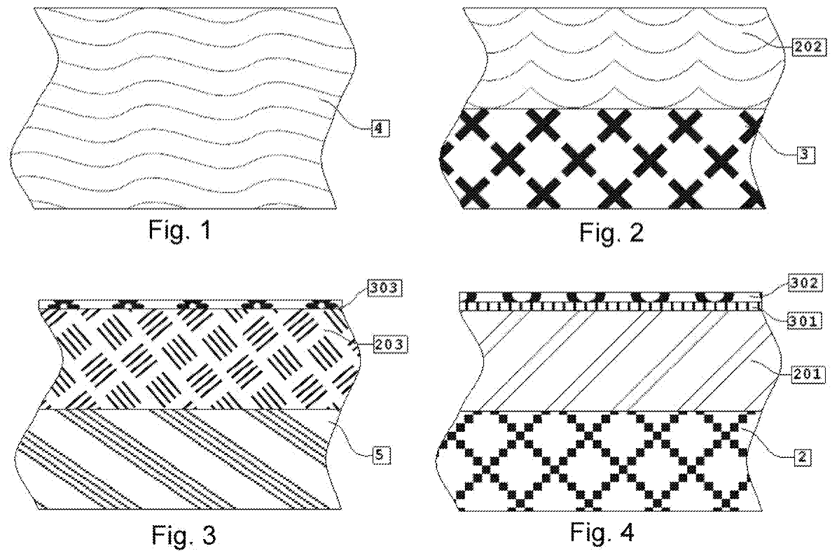

### Example 1 (FIG. 1)

Using a homogenizer/emulsifier, 490 g of demineralized and deionized water were added to a beaker and 10 g of photocatalytic titanium dioxide were gradually added and the solution emulsified. An ingredient of the first semi-finished product was made.

In a kneader, to 787 g of porphyry having a grain size from 0 to 2.0 mm, were added 79 g of a previously prepared titanium dioxide solution and the compound was mixed. 29 g of sodium hydroxide were then added to the previous mixture and the mixture was mixed. 73 g of calcined kaolin were added to the previous mixture and the mixture was mixed. 32 g of sodium silicate containing potassium hydroxide were added to the previous mixture and the compound was mixed. Our semi-finished product (4) was obtained. The semi-finished product is stored in a particular tank for a maximum of 50 minutes. It is then discharged into a suitable steel mold and is vibrated on specially made supports and pressed for 20 seconds by an industrial press which applies several tons of pressure. A tile can be created, for example having dimensions of 300 by 300 mm and 40 mm high.

### Example 2 (FIG. 2)

Using a magnetic stirrer in a beaker, 470 g of demineralized and deionized water and 30 g of glacial acetic acid were added and left to stir for a few minutes. 200 g of photocatalytic titanium dioxide, 50 g of hydrophilic colloidal silica and 50 g of hydroxyapatite were added and the solution was mixed to eliminate lumps. A component was made.

To a kneader, 564 g of silica sand with a grain size of from 0 to 2 mm were added to 305 g of gravel having a grain size of 6 to 8 mm and the compound was mixed. 29 g of sodium hydroxide were added to the previous mixture and the mixture was mixed. 73 g of calcined kaolin were added to the previous mixture and the mixture was mixed. 29 g of sodium silicate containing potassium hydroxide were added to the previous mixture and the compound was mixed. Our first semi-finished product (3) was obtained.

At the same time to another mixer were added 859 g of silica sand having a grain size from 0 to 2 mm to 10 g of the previously prepared photocatalytic titanium dioxide, 29 g of sodium hydroxide and at the same time the compound was mixed. 73 g of calcined kaolin were added to the previous mixture and the mixture was mixed. 29 g of sodium silicate were added to the previous mixture and the mixture was mixed. Our second semi-finished product (202) was obtained.

The two semi-finished products are stored in special tanks for a maximum of 50 minutes. Said semi-finished products are unloaded into a suitable steel mold according to the sequence: 1st semi-finished product, 2nd semi-finished product. Then, when the first semi-finished product is unloaded, it is vibrated on specially made supports and pressed for 10 seconds by an industrial press which applies several tons of pressure. Immediately afterwards, the second semi-finished product is discharged into the same steel mold and is vibro-compressed for a further 15 seconds, again using the same industrial press. The first semi-finished product has a weight ratio of about 92% with respect to the second semi-finished product which represents a weight ratio of about 8-9% in the production of a self-locking block, which, for example, may be 60 mm high, of which 55 mm are represented by the first semi-finished product and 5 mm by the second semi-finished product.

### Example 3 (FIG. 3)

Using a magnetic stirrer in a beaker, 350 g of 99.9% pure ethanol were added to 200 g of an amorphous colloidal solution based on titanium dioxide doped with nitrogen produced by synthesis from titanium tetrachloride (TiCL₄) in isopropyl alcohol and concentrated at 10.0%. To 100 g of titanium dioxide were added 400 g of H₂O and the compound was emulsified for a total time of 60 minutes. At the end, a surfactant solution based on a modified polyether was added in the amount of 0.01 g and stirred again for 10 minutes. This particular type of photocatalytic titanium is ideal for vitreous and active surfaces in the spectrum up to 480 nm.

To a kneader, 534 g of silica sand with a grain size of from 0 to 2 mm were added to 305 g of gravel having a grain size of 6 to 8 mm and the compound was mixed. 30 g of zeolite were added and the compound was mixed. 29 g of sodium hydroxide were added to the previous mixture and the mixture was mixed. 73 g of calcined kaolin were added to the previous mixture and the mixture was mixed. 29 g of sodium silicate containing potassium hydroxide were added to the previous mixture and the compound was mixed.

A first semi-finished product (5) was obtained.

At the same time in another mixer, 840 g of photo-luminescent glass grit having a grain size from 0 to 3.0 mm were added to g of calcined kaolin at the previous mixture and the compound was mixed. 37 g of sodium silicate containing potassium hydroxide were added to the previous mixture and the compound was mixed.

A second semi-finished product (203) was obtained.

The two semi-finished products are stored in special tanks for a maximum of 50 minutes. Said semi-finished products are unloaded into a suitable steel mold according to the sequence: 1st semi-finished product, 2nd semi-finished product. Then, when the first semi-finished product is unloaded, it is vibrated on specially made supports and pressed for 10 seconds by an industrial press which applies several tons of pressure. Immediately afterwards, the second semi-finished product is discharged into the same steel mold and is vibro-compressed for a further 15 seconds, again using the same industrial press. The first semi-finished product has a weight ratio of about 92% with respect to the second semi-finished product which represents a weight ratio of about 8-9% in the production of a self-locking block, 60 mm high, of which 55 mm are represented by the first semi-finished product and 5 mm by the second semi-finished product. Once the self-locking block is formed, the layer means (303) or 30 g/m² of amorphous colloidal photocatalytic titanium dioxide previously prepared is added along a specially designed line using an HVLP airless system and left to dry at room temperature.

### Example 4 (FIG. 4)

To a beaker were added 500 g of demineralized and deionized water. Using a magnetic stirrer with a hot plate, the temperature was set to 100° C. When the water reaches 45° C., 10 g of smectite are added and stirred for 5 minutes. 10 g of photocatalytic titanium are added and stirred for a further 5 minutes. 0.05 g of modified polyether are added and stirred for a further 5 minutes. The solution is sonicated and emulsified. To a kneader, 564 g of silica sand with a grain size of from 0 to 2 mm were added to 305 g of gravel having a grain size of 6 to 8 mm and the compound was mixed. 29 g of sodium hydroxide were added to the previous mixture and the mixture was mixed. 73 g of calcined kaolin were added to the previous mixture and the mixture was mixed. 29 g of sodium silicate were added to the previous mixture and the mixture was mixed.

A first semi-finished product (2) was obtained.

At the same time in another mixer were added 840 g of marble powder with a grain size from 0 to 3.0 mm to 29 g of sodium hydroxide and 29 g of zeolite and at the same time the compound was mixed, adjusting the humidity, just enough to make the mixture workable. 73 g of calcined kaolin were added to the previous mixture and the mixture was mixed. 29 g of sodium silicate containing potassium hydroxide were added to the previous mixture and the compound was mixed.

A second semi-finished product (201) was obtained.

The two semi-finished products are stored in special tanks for a maximum of 50 minutes. Said semi-finished products are unloaded into a suitable steel mold according to the sequence: 1st semi-finished product, 2nd semi-finished product. Then, when the first semi-finished product (2) is unloaded it is vibrated on specially made supports and pressed for 10 seconds by an industrial press which applies several tons of pressure. Immediately afterwards, the second semi-finished product (201) is discharged into the same steel mold and is vibro-compressed for a further 15 seconds, again using the same industrial press. The first semi-finished product has a weight ratio of about 92% with respect to the second semi-finished product which represents a weight ratio of about 8-9% in the production of a self-locking block, 60 mm high, of which 55 mm are represented by the first semi-finished product and 5 mm by the second semi-finished product. Once the self-locking block is formed, the first layer means (301) or 50 g/m² of a hydrophobic primer are added along a specially designed line using an HVLP airless system and dried with the aid of hot air ventilation. Subsequently the second layer means (302) is added, i.e. 60 g/m² of photocatalytic titanium dioxide previously prepared and dried.

In the examples given so far, the various semi-finished components composing the first layer means (2), (3), (4) and (5) can be replaced with each other. The semi-finished products (4), (201), (202) and (203) composing the first and second layer means are also replaceable with each other. The further layer means (301), (302) and (303) are replaceable with each other. To the examples given above, further layer means mentioned in the present invention can be added.

### Results of Experiments Conducted

### Photocatalytic Analysis

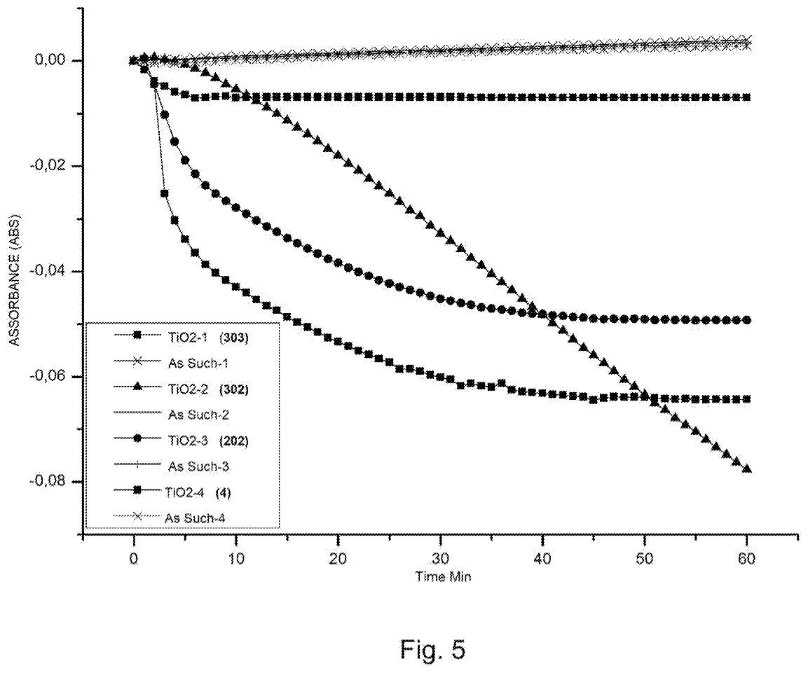

To analyze the photocatalytic solutions based on amorphous colloidal titanium dioxide 4, 202, 302 and 303, we used a laser beam UV-Vis spectroscope which measures photocatalytic activity through absorbance variations resulting from the decomposition of pollutants (organic pigments) by a photocatalyst. It basically consists of a unit (sensor unit) which includes: two lamps, one for the UV (black light) and one for the visible, an emitter element and a light receiving element. The incident light beam is characterized by the wavelength relative to the absorbance of Methylene Blue, 660 nm. The intensity of each light signal reaching the receiver corresponds proportionally to an electrical signal, therefore, by defining transmittance T as the fraction of incident light that is transmitted by a material, the instrument will detect this quantity with % T=(Vn−V0)/(V100−V0)×100 in which in the denominator the electric signal relative to the incident light ray appears (acquired by the receiver putting a completely reflecting surface) while at the numerator there is the electric signal relative to the light ray transmitted after a time n. As can be seen in the formula, both electrical signals are reduced by the term V0 relative to that portion of light that does not reach the receiver (obtained by placing the sensor on one side so that the receiver can acquire only an infinitesimal fraction of the transmitted beam). What has been said so far can also be clearly extended to absorbance, which is defined as the decimal logarithm of the transmittance reciprocal: A=log10(1/T). Consequently the output of the instrument can be expressed in terms of Transmittance (% T), Absorbance (ABS) and/or Voltage (V). The instrument is calibrated before each analysis. Furthermore, the instrument is equipped with two independent channels, CH1 and CH2, which allow measurements to be made simultaneously on portions of a substrate treated and not treated with titanium dioxide. Four comparative analyses are carried out each on a different substrate, comparing each photocatalytic solution with an uncoated portion which we will call As Such of the layer and semi-finished products 4, 202, 302 and 303. The graph of FIG. 5 shows that the best photocatalytic activity in terms of decomposition speed of the organic compounds deposited on the surface, with the same quantity, is that of Titanium 303, instead the best performance in terms of absorbance is that of Titanium 302.

NOx decay analysis “Determination of the degradation activity of nitrogen oxides in air by photocatalytic inorganic materials” UNI EN 11247.

Photoactivity tests are performed on air added with NOx (NO+NO₂) in order to simulate a plausible degree of atmospheric pollution.

The initial concentration of gas injected into the 3 liter reactor ±20% according to 11247 must be distributed as follows:

NOx=0.55±0.05 ppm; NO=0.4±0.05 ppm; NO₂=0.15±0.05 ppm.

To calculate the concentration in μg/m³, consider the formula (ĪĪĪ):

NOx μg/m³=(NO ppb+NO₂ ppb)×(f) (ĪĪĪ)

where (f) is 1.91 and 1.88 respectively at 20° C. and 25° C. For the activation of Titanium Dioxide a Vitalux lamp is used with a power of 300 Watts and light emission at 365 nm at a distance such that the UVA irradiance recorded through photo radiometer on the surface of the sample is equal to 20±1 W/m².

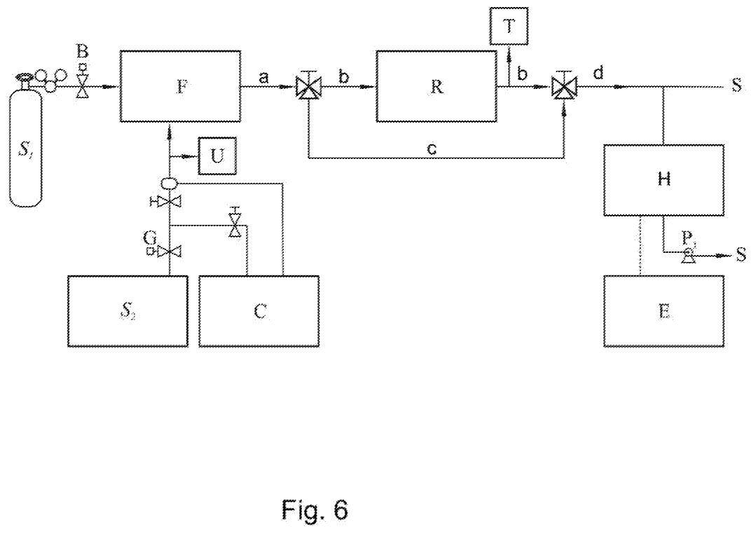

The description of the experimental apparatus is illustrated in FIG. 6.

For the gas transfer, polytetrafluoroethylene tubes were used, a material with characteristics that do not alter the concentration of nitrogen oxides. The valves on the a-b-c and b-c-d circuit are made of Pyrex glass, the gas supply, with constant flow, regulated at the outlet of the S₂ cylinder (1±0.1) 1/min. Humidity considerably influences the photocatalytic activity. It is necessary, therefore, that the humidity content of the gas flow is set at the optimal value of 50±10%. This is achieved by passing gas, or zero air, (taken from the cylinder S₂) into the chamber C containing water and measuring the degree of humidity with a laboratory hygrometer. Computer controlled digital flow meters B and G are used for the precise delivery of gases S₁ and S₂. With reference to the scheme of the instrumental apparatus shown in FIG. 6, the measurements of the initial concentration of the Nitrogen Oxides are determined with the following procedure:

Initially, using a probe (U), the values of the relative humidity of air S₂ are acquired, which is mixed with the lung flow regulator (F) with the NOx gas (NO+NO₂) supplied by the cylinder (S₁). At this point it is possible to proceed with the measurement of the concentration of nitrogen oxides, conveying the flow to the analyzer (H) through the a-c-d path which excludes the reactor. Data is read on computer E. The concentration value is recorded when it is constant (with deviation <5%) for at least 10 minutes. In order to avoid overpressure and eliminate the residual NOx inside this experimental apparatus, a purge (S) is made from which excess air is eliminated. The analyzer is also equipped with a purge S which occurs through the pump Pi. Subsequently the concentration of the nitrogen oxides coming out of the photochemical reactor (R) in the dark (C_{B}), procedure called “White Chamber”, is measured, conveying the gas to the analyzer (H) through the path a-b-d, excluding the line c. The test is considered completed when the concentration C_{B} is constant (with a deviation <5%) for at least 10 minutes. The concentration of nitrogen oxides coming out of the photochemical reactor under illumination (C_{L}) is then measured, which is determined by conveying the gas to the analyzer through the path a-b-d, excluding the line c. During the whole test the temperature is monitored through a digital thermometer (T). The test is considered completed when the concentration C_{L} is constant (with a deviation <5%) for at least 10 minutes. For the duration of the test the following must be kept constant:

Supply flow at a value of 5.0±10% 1/min;
The temperature at a value of 27±2° C.;
Relative humidity at a value of 50±10%.

### Results

The photocatalytic abatement activity of nitrogen oxides, A_{F} (mh⁻¹), for different reaction times, can therefore be calculated from (ĪĪĪĪ):

$${A}_{F} = \frac{( {C}_{B} - {C}_{L} )}{{C}_{B}} \times \frac{F}{S} \times I \qquad ( \overline{I} \overline{I} \overline{I} \overline{I} )$$

where:
C_{B} and C_{L} are the concentrations (NOx, NO₂, NO) defined above;
S=the geometric area of the sample under examination in m²;
F=the gas flow expressed in m³/h;
I=1000/I′ where I′ is experimentally measured irradiance.

For each individual sample of photocatalytic material, the calculation of A_{F} will concern NOx, NO and NO₂.

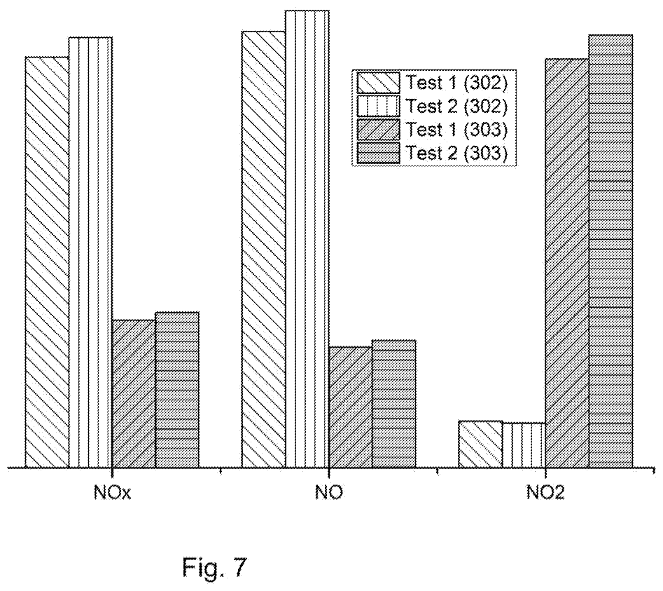

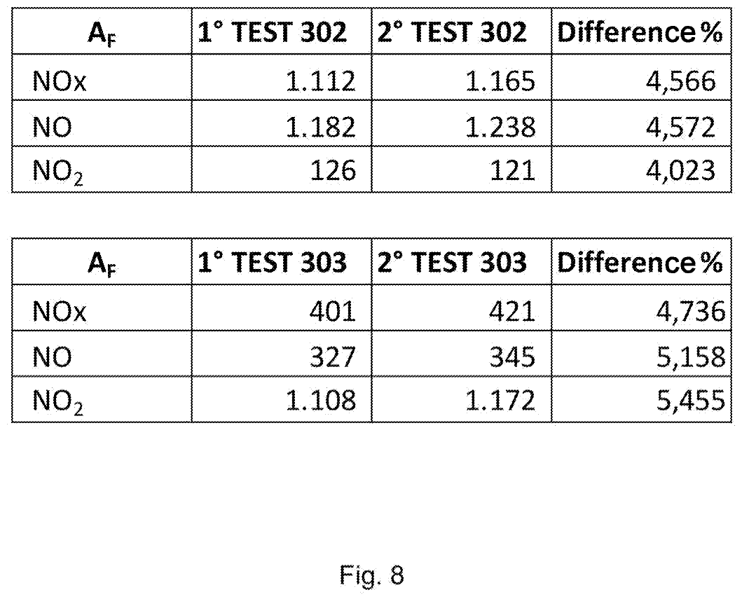

We analyzed the specimens of FIG. 1 containing titanium dioxide 302 and of FIG. 4 containing titanium dioxide 303. The comparative graph is shown in FIG. 7, the results A_{F} are shown in the table of FIG. 8.

Determination of the sclerometric index according to UNI EN 12504-2:2012. Non-destructive tests.

To check the surface hardness of the semi-finished products complete with layer means, a digital sclerometer was used with an impact energy in a measurement range from 1-25 N/mm₂. The instrument automatically excludes the values of the rebound index (I_{R}) that do not comply with the standard and automatically determines the value of R (compressive strength laid on site). The tolerance of the instrumental measurement is ±0.1R and the value of the resistance class is measured in N/mm₂. The method consists in causing the impact of a conventional mass against the surface of the material being tested and in measuring the height of the rebound; the measurement is expressed in terms of percentage of the rebound height with respect to the distance traveled by the moving mass between the instant in which it is released and when it hits the surface of the concrete. This percentage is called the rebound index (I_{R}). Considering that the kinetic energy of the striking mass is standard, the rebound height depends on the energy dissipated during the impact which, in turn, depends on the mechanical strength of the concrete surface. The test will be comparative, i.e. between a concrete block and a geopolymer made in this patent. For this purpose, the photocatalytic geopolymer used is composed of the semi-finished product 3 and 202.

Both the photocatalytic geopolymer and the solid concrete are made of 2 semi-finished products, the first semi-finished product has a weight ratio of 91.7% compared to the second semi-finished product representing a weight ratio of 8.3% in size they are 60 mm high, or 55 mm are represented by the first semi-finished product, 5 mm are of the second semi-finished product. The dimensions of the two specimens are 10×20×6 h cm (the standard envisages cm. 20×20×15 h but relates to the concrete laid on site) for each specimen 12 measurements are made in 4 zones, equidistant to each other by 40 cm, along the central line of the specimen, where a is the angle of inclination of −90°. Before testing, the instrument is calibrated with a special calibration anvil.

### Results:

Concrete sample: Average of 12 values R=22.5; Resistance Class N/mm₂=4.1;

Photocatalytic geopolymer sample: Average of 12 values R=25.0; Resistance class N/mm₂=7.3.

1. A process for the preparation of a manufactured building article, the process comprising the following steps:
I) mixing sand, sodium hydroxide and possibly additives,
II) adding calcined kaolin to the mixture obtained from step I),
III) adding sodium silicate and/or a mixture of sodium silicate and potassium hydroxide to the mixture obtained from step II) obtaining said manufactured building article or a semi-finished product of said manufactured building article, and IV adding photocatalytic titanium dioxide.

2. The process according to claim 1, wherein in step I) zeolite is added as an additive.

3. The process according to claim 1, wherein gravel is added to the mixture of step I).

4. The process according to claim 3, wherein in step I) sand is replaced with a powdered material selected from the group consisting of: powders of marble, quartz, granite, porphyry, travertine, basalt, mixed stone, grits, glass, ceramic, earthenware, terracotta, and metal powders.

5. The process according to claim 4, wherein said powdered material has a granulometry comprised between about 0.01 and 6 mm.

6. The process according to claim 1, wherein the photocatalytic titanium dioxide is added in step I) in the form of a hydrophilic solution or amorphous colloidal solution.

7. The process according to claim 1, wherein the photocatalytic titanium dioxide is added by application to said manufactured building article or to said semi-finished product of the manufactured building article.

8. The process according to claim 6, wherein said amorphous colloidal solution comprises one or more compounds selected from: hydroxyapatite, amorphous colloidal silica, modified polyether, surfactants.

9. A manufactured building article obtained according to the process of claim 1.

10. A process for the preparation of a composite building article, the process comprising the following steps:
providing in a mold a first semi-finished product obtained with the process according to claim 1 before the first semi-finished product dries,
vibro-compressing said first semi-finished product for a sufficient time,
superposing a second semi-finished product to said first semi-finished product before the second semi-finished product dries, and
vibro-compressing said first and said second semi-finished products, obtaining the composite building article.

11. The process according to claim 10, further comprising the step of:
IV) applying on said composite building article a first layer represented by a preparation having a hydrophobic, or antifreeze or reflecting/luminescent property, or said first layer being represented by a preparation comprising titanium dioxide, on said first layer being applied a second layer represented by a preparation having a hydrophobic, or antifreeze or reflecting/luminescent property.

12. The process according to claim 11, wherein said first layer and/or said second layer further comprise other powdered, liquid, microsphere, glass grit, laminar material or any other form for mixing.

13. The process according to claim 10, comprising applying said first and/or said second layer by spray coating or by mixing.

14. A manufactured building article obtained according to the process of claim 10.

15. The manufactured building article according to claim 14, the manufactured building article being subjectable to further treatments selected from the group consisting of: smoothing, bush-hammering, brushing, sandblasting, tumbling and treatments capable of imparting a greater added value to a finished article.

16. The manufactured building article according to claim 9, wherein the manufactured building article is one among a tile, a slab, panels, shingles, a self-locking block, gutters and channels for collecting water, guardrails, structures for tunnels, bulkheads, curbs.

17. The process according to claim 4, wherein said powdered material has a granulometry comprised between about 0.1 and 3 mm.
